(19) United States
(12) Patent Application Publication
(10) Pub. No.: US 2014/0202723 A1
(43) Pub. Date: Jul. 24, 2014

(54) AERIAL BUCKET LIFT ELECTRICAL FIRE SAFETY APPARATUS

(71) Applicant: GelTech Solutions, Inc., Jupiter, FL (US)

(72) Inventor: Peter Cordani, Palm Beach Gardens, FL (US)

(73) Assignee: GelTech Solutions, Inc., Jupiter, FL (US)

(21) Appl. No.: 14/109,740

(22) Filed: Dec. 17, 2013

Related U.S. Application Data
(63) Continuation-in-part of application No. 14/045,386, filed on Oct. 3, 2013.
(60) Provisional application No. 61/754,068, filed on Jan. 18, 2013.

(51) Int. Cl. A62C 3/07

(52) U.S. Cl. CPC A62C 3/07
USPC 169/62

(57) ABSTRACT

An apparatus for protecting a lineman, firefighter or any other individual using an aerial bucket from a fire. The apparatus dispenses a non-conductive admixture of hydrated super absorbent polymer having fire suppression and extinguishing properties without creating an electrically conductive environment to allow protection from electrical fires. The admixture can cling to clothing and skin with properties that can inhibit injury to an operator lineman when applied in time. A pressurized dispensing system discharges the admixture into the aerial bucket when authorized.

### PRIORITY STATEMENT

In accordance with 37 C.F.R. 1.76, a claim of priority is included in an Application Data Sheet filed concurrently herewith. Accordingly, the present invention is a continuation-in-part of U.S. patent application Ser. No. 14/045,386, entitled “Device for Treating Manhole Electrical Fires” filed Oct. 3, 2013, which claims the priority date of U.S. Provisional Patent Application No. 61/754,068, entitled “Device for Treating Manhole Electrical Fires”, filed Jan. 18, 2013. The contents of the above referenced applications are incorporated herein by reference.

### FIELD OF THE INVENTION

This invention relates to the field of safety equipment, and more particularly, to an apparatus for use with an aerial bucket for dispersion of an admixture of a hydrated super absorbent polymer to shield a worker from an electrical fire.

### BACKGROUND OF THE INVENTION

Electrical utilities that are mounted on a pole pose a unique servicing problem. In particular, the utilities are exposed to the elements wherein insulating properties can be lost in a short time span. Between exposure to the elements and overloading of circuits, a failure of the electrical lines is bound to occur. Lineman who service the above ground utilities typically employ an aerial bucket lift that is mounted on a vehicle. Should the lineman improperly touch a live line, or should the electricity be turned on while a lineman is servicing what he thought was unpowered, an immediate arcing and possible electrical fire occurs. Electrical fires pose a danger due not only to the heat and products of combustion produced from a typical fire, but the potential for electrocution due to leakage back to the lineman.

Unfortunately, even an inspection of a line can trigger a fire. For instance, the movement of a line can result in arcing wherein only insulation can provide fuel for a fire. Normally a lineman inspecting potential problem areas takes place while electrical power is still flowing through the lines. This takes place while the lineman is in the aerial bucket placed adjacent to a powerline. The minimum current a human can feel depends on whether the current is AC or DC and at what frequency. A person may be able to feel 1 mA or AC at 60 Hz, but no pain would occur. At around 10 mA, AC current can cause muscle contractions and the human would be unable to voluntarily control their muscles. A current of more than 30 mA of AC can cause fibrillation. Should the lineman trigger an arc and/or cause a fire, the lineman's escape is to move the aerial bucket. Typically, the natural reaction for the lineman is duck within the aerial bucket and hope his co-workers can move him. In many such instances, the lineman who climbed into the aerial bucket is now at risk of injury or death.

While linemen servicing power poles is defined as example throughout this specification, any use of an aerial bucket is deemed within the scope of this invention including firefighting aerial buckets found on fire trucks.

What is needed is a device that provides protection to an individual that employs an aerial bucket.

### DESCRIPTION OF THE PRIOR ART

U.S. Pat. No. 7,096,965 discloses a method of proportioning a foam concentrate into a non-flammable liquid to form a foam concentrate/liquid mixture and create a flowing stream of the foam concentrate/liquid mixture. Nitrogen is introduced into the stream of the foam/liquid mixture to initiate the formation of a nitrogen expanded foam fire suppressant. The flowing stream carrying the nitrogen expanded foam is dispensed, which completes the full expansion of the nitrogen expanded foam fire suppressant, into the confined area involved in the fire, thereby smothering the fire and substantially closing off contact between combustible material involved in the fire and the atmosphere. The apparatus of this invention is adapted for expanding and dispensing foam and includes a housing defining an interior through which extends a discharge line. The ends of the housing are closed about the ends of the discharge line, and the ends of the discharge line extend beyond the ends of the housing to define a connector at one end for receiving a stream of foam concentrate/liquid and at the opposite end to define the foam dispensing end of the apparatus. A portion of the discharge line in the housing defines an eductor for the introduction of expanded gas into the stream of foam concentrate/liquid flowing through the discharge line.

U.S. Pat. No. 7,104,336 discloses a method and apparatus for proportioning foam concentrate into a non-flammable liquid to form a foam concentrate/liquid mixture and create a flowing stream of the foam concentrate/liquid mixture similar to the method and apparatus of U.S. Pat. No. 7,096,965.

U.S. patent application Ser. No. 11/680,803 is entitled “Process for Fire Prevention and Extinguishing”, the contents of which are incorporated herein by reference. In this application, a process for retarding or extinguishing conflagrations using a super absorbent polymer is disclosed.

U.S. Pat. No. 5,989,446 discloses a water additive for use in fire extinguishing and prevention. The additive comprises a cross-linked water-swellable polymer in a water/oil emulsion. The polymer particles are dispersed in an oil emulsion wherein the polymer particles are contained within discrete water “droplets” within the oil. With the help of an emulsifier, the water “droplets” are dispersed relatively evenly throughout the water/oil emulsion. This allows the additive to be introduced to the water supply in a liquid form, such that it can be easily educted with standard firefighting equipment.

U.S. Pat. No. 5,190,110 discloses the fighting of fires or protection of objects from fire by applying water which comprises dispersing in the water particles of a cross-linked, water-insoluble, but highly water-swellable, acrylic acid derivative polymer in an amount sufficient to raise the viscosity. Advantageously, the particles are present in an amount such that, after swelling, the swollen particles hold 60 to 70% by weight of the total water; the polymer being a copolymer of an acrylic acid, the water containing silicic acid and/or a silicate as well as sodium, potassium or ammonium ions. The water is freely pumpable, but the swollen particles adhere to surfaces they contact rather than running off rapidly.

U.S. Pat. No. 5,849,210 discloses a method of preventing or retarding a combustible object from burning including the steps of mixing water with a super absorbent polymer (“SAP”) to form one at least partially hydrated SAP, and applying the at least partially hydrated SAP to the combustible object, before or after combustion. In another embodiment, an article of manufacture includes a SAP that is prehydrated and is useful for preventing a combustible object from burning, or preventing penetration of extreme heat or fire to a firefighter or other animal.

### SUMMARY OF THE INVENTION

An apparatus for suppressing and extinguishing electrical fires in aerial buckets is disclosed. The device includes a distribution ring that is placed over the aerial bucket and distributes a hydrated super absorbent polymer into the aerial bucket in an amount sufficient to cover the individual. The apparatus includes a container capable of holding pressurized hydrated super absorbent polymer. At least one compressed gas tank is coupled to the container for pressurization of the container storing the hydrated polymer. A battery operated solenoid is secured to a pressurized outlet of the container; the solenoid can be opened by at least one remote activator that is held by the lineman using the aerial bucket, or by a co-worker. Should the lineman working in the aerial bucket be subjected to an electrical fire, the lineman can activate the trigger and dispense the non-conductive hydrated polymer into the aerial bucket where the spray nozzle will coat the lineman. While linemen servicing power poles is defined, any use of an aerial bucket is deemed within the scope of this invention including firefighting aerial buckets found on fire trucks.

The hydrated super absorbent polymer has substantially superior fire suppression and extinguishing properties than the fire suppression and extinguishing properties of plain water. One of the unique properties of the admixture is its ability to cling to any object to which it has been applied, and both cool down the object after it is on fire and create a block to inhibit fire spreading over the object. The hydrated super absorbent polymer mixture has a predetermined viscosity and is distributed in a manner to be contained within a specific area without spreading to adjacent areas. These superior properties enable electrical fires to be extinguished more rapidly and not flare back up.

The admixture disclosed herein maintains a leakage below 0.9 mA at 15 feet for 11,000 volts and 20 feet for 30,000 volts.

Accordingly, it is an objective of the present invention to provide an apparatus for use in combination with an aerial bucket for suppressing fires that could affect the individual employing the aerial bucket.

It is a further objective of the present invention to provide an apparatus that permits activation by the individual in the aerial bucket, or a person outside the aerial bucket, to release material capable of extinguishing electrical fires and suppressing the spread of electrical fires in the aerial bucket; the trigger is based upon a battery operated solenoid valve that is either coupled by hard wire or by use of a wireless RF transmitter/receiver.

It is still yet another objective of the present invention to provide an apparatus to work with an admixture of super absorbent polymer which has a viscosity to retain a shape for a period of time. The viscosity also enables the admixture to adhere to horizontal, vertical, inclined, and curved surfaces.

It is a still further objective of the present invention to provide a device for protecting of personnel, and extinguishing or suppressing of an electrical fire, which results in a rapid and less expensive cleanup process.

It is another objective of the present invention to provide a device for protecting lineman servicing power poles using an aerial bucket.

It is another objective of the present invention to provide a device for protecting firefighters using an aerial bucket to put out fires.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a pictorial view of a vehicle mounted aerial bucket lift;

FIG. 2 is a perspective view of an aerial bucket with a distribution ring;

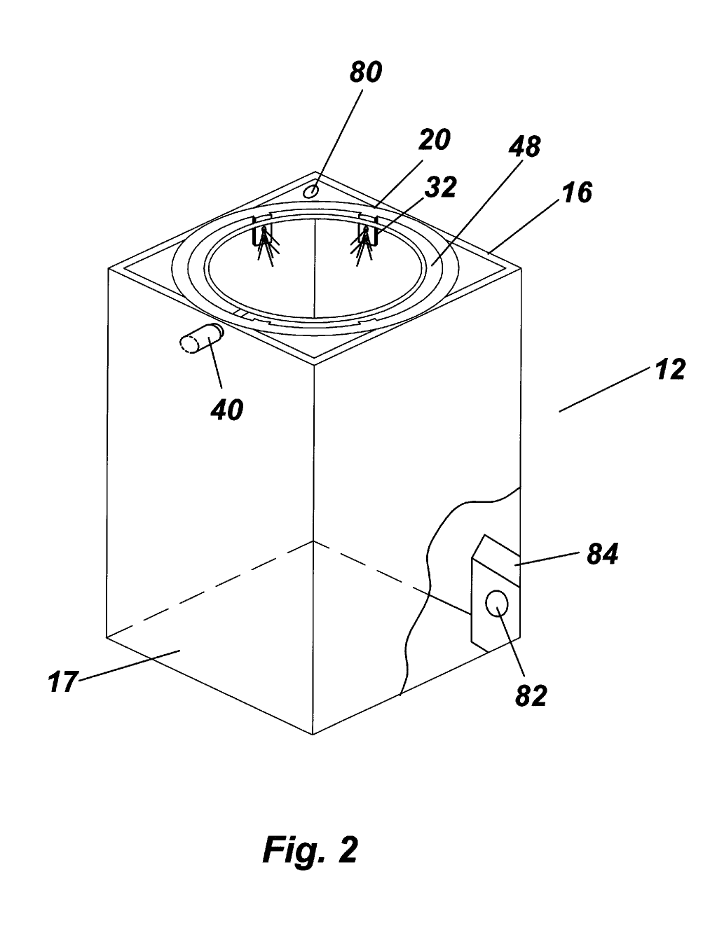

FIG. 3 is a pictorial view of an individual within the aerial bucket; and

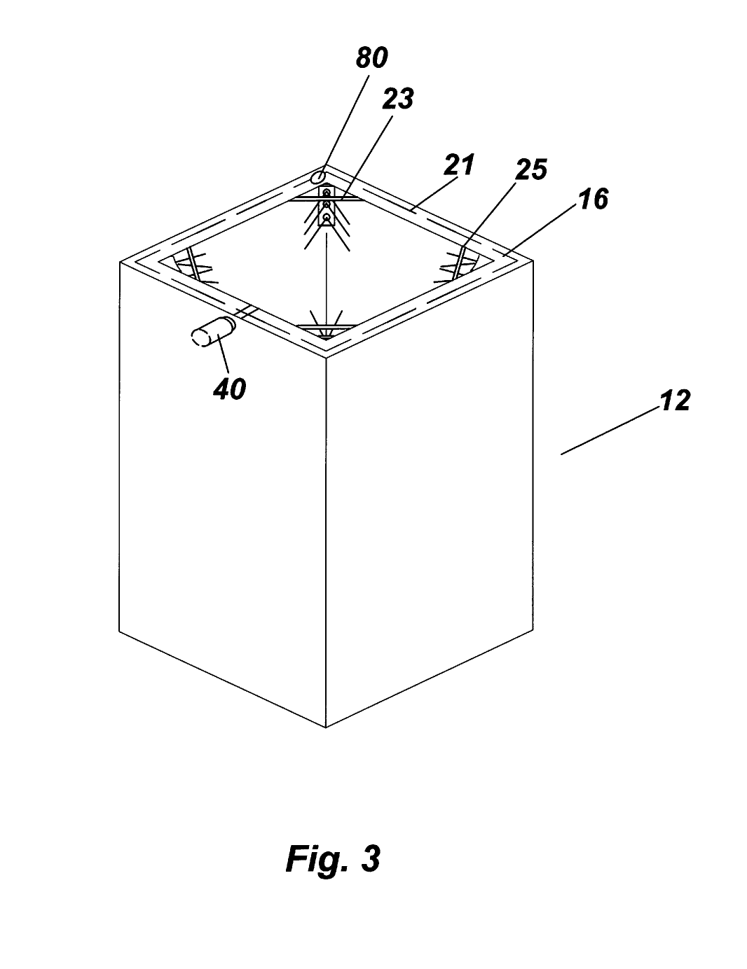

FIG. 4 is a flow diagram of the components used for the aerial bucket lift electrical fire safety apparatus.

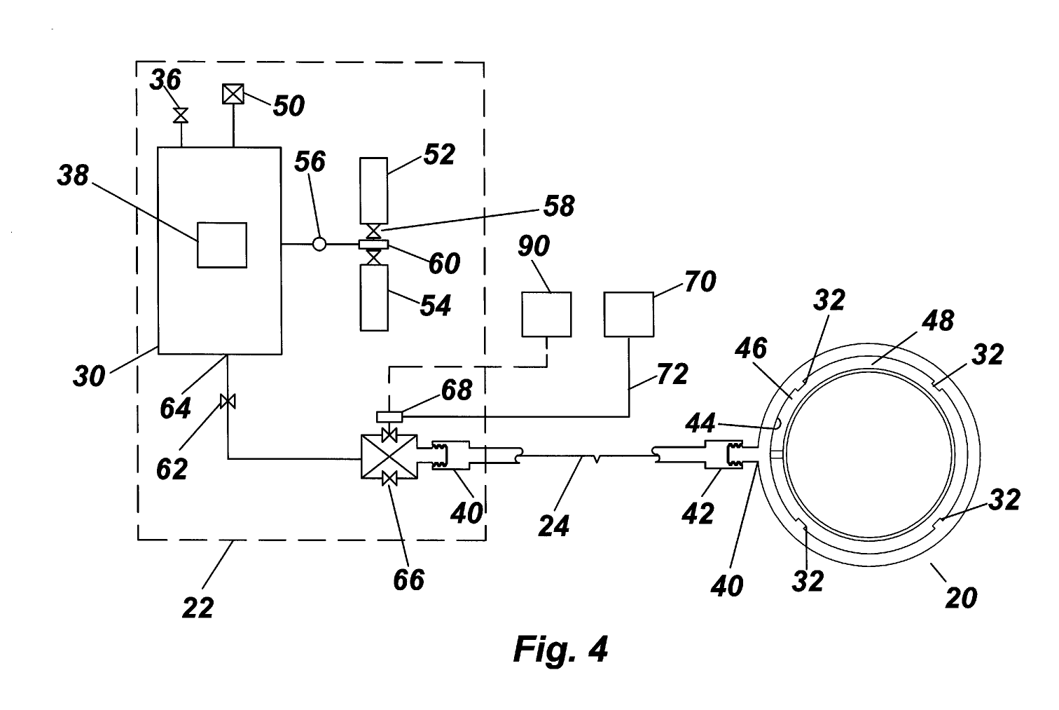

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

The present invention relates to a unique technique or method of protecting an individual suspended in an aerial bucket from an electrical fire, and for extinguishing/suppressing the spread of electrical fires. This technique utilizes a super absorbent polymer and water in a predetermined amount. The super absorbent polymer is biodegradable, super absorbent and aqueous based. Examples of these polymers are cross-linked modified polyacrylamides/potassium acrylate or polyacrylamides/sodium acrylate. Other suitable polymers include, albeit not limited to, carboxy-methylcellulose, alginic acid, cross-linked starches, and cross-linked polyaminoacids. The preferred super absorbent polymer is marketed under the trademark FIREICE® by Geltech Solutions Inc., located in Jupiter, Fla.

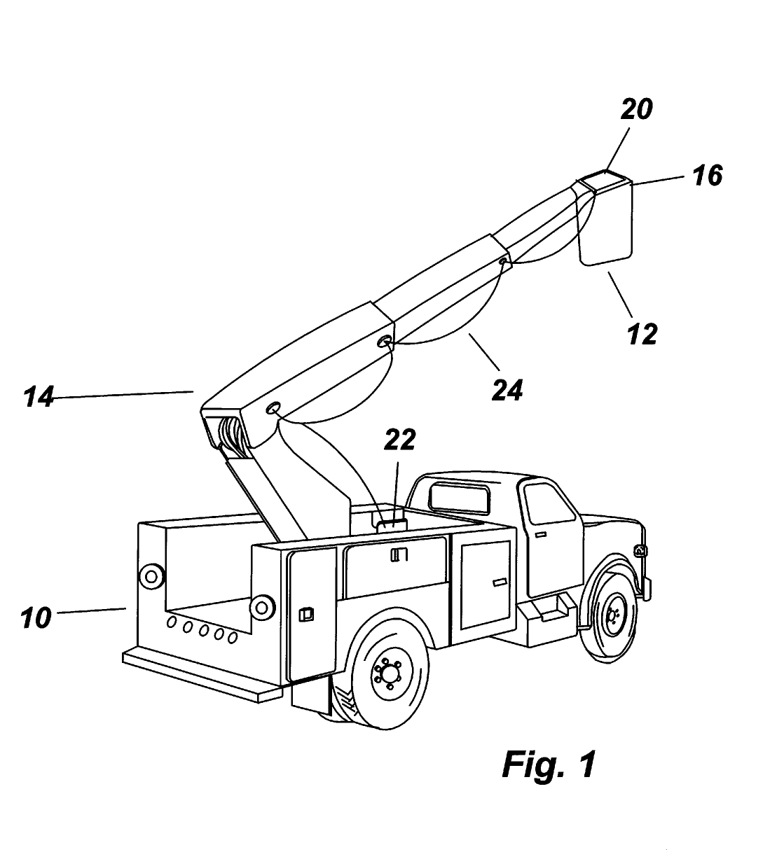

Referring to the FIG. 1, illustrated is a vehicle 10 having an aerial bucket 12 positioned at the end of a hydraulic driven lifting boom 14. The instant invention can be installed on a new or existing vehicle wherein a dispensing ring 20 is secured to the top 16 of the aerial bucket 12. The dispensing ring 20 is coupled to a self contained suppression system 22 placed in the vehicle by a flexible hose 24. The present invention is used to protect personnel that are within the aerial bucket should they be subject to electrical fire. Electrical fires present different and unique problems pertaining to how these fires should be extinguished and suppressed. Water is normally used to fight fires because it can quickly cool down the burning material. However, water and electricity are harmful, if not deadly to individuals, when brought into contact with each other. Normally, when water hits an active electrical circuit or electrical component, it shorts out the circuit or component, which usually results in destruction of the circuit or component. When an individual is in close proximity to the electrical wire, use of water can act as a conductor and conduct the electricity to the individual, resulting in serious injury or death. Since water spreads rapidly in all directions on surfaces, electricity which comes in contact with the water will be conducted to wherever the water flows. Because it is difficult to prevent water from flowing to certain areas, there is a strong likelihood that individuals will be injured or killed when they come in contact with this water. When a lineman is working from an aerial bucket, should the lineman cause an electrical arc or related electrical fire, the natural inclination of the lineman is to retreat into the bucket and shield himself from situation. The operation of the instant invention is to immediately douse the lineman with the admixture which will temporarily shield the lineman from the electric fire while the aerial bucket is moved. The adherence of the admixture of super absorbent polymer and water to the clothing of the lineman lowers the temperature of the clothing below a combustion temperature, thereby giving the individual time to remove himself from the situation. In addition, adherence of the admixture of super absorbent polymer and water to the clothing maintains moisture content at a level which suppresses the spread of the fire by preventing combustion of the clothing from hot embers and/or flames. Most importantly, placing the admixture upon exposed skin deters burning of the skin. While in the aerial bucket, the admixture is dispersed at such a high rate the individual will instantly be soaked with the admixture.

Currently, water is not used to douse an electrical wire that is on fire. The present invention, on the other hand, enables a water to be made non-conductive by use of a controlled dispersion of super absorbent polymer for the primary purpose of protecting the individual from the fire, and giving the individual time to escape the situation. In the preferred embodiment of the present invention, a hydrated admixture of the super absorbent polymer is placed within a container 30. The admixture has properties which enable the super absorbent polymer and water to be applied over the individual and remain within the confined area because of its relatively high viscosity. The properties of the admixture, in particular its viscosity, also enable the admixture to remain on surfaces of the bucket and the individual within the bucket. Unlike pure water, the material does not provide an electrically conductive path permitting the individual time to get out of the bucket without being electrocuted. The present invention adds a predetermined amount of the super absorbent polymer to a predetermined amount of water to obtain an admixture which has properties that enable the admixture to suppress the spread of an electrical fire and extinguish any fire that has attached itself to the individual. The preferred predetermined amounts are 2-4 pounds of dry super absorbent polymer to 30 gallons of water.

Referring to the Figures, the container 30 holding the FireIce® hydrated super absorbent polymer is positioned a distance from aerial bucket 12. An aerial bucket sized to allow a lineman enough room to crouch into is the preferred embodiment, wherein spray nozzles 32 placed on the top 16 of the aerial bucket 12 dispense into the aerial bucket. An alternative embodiment is to have spray nozzles 32 point upward and downward if an aerial bucket is undersized. In this embodiment, the lineman can still receive an efficient coating, but wind and the size of the individual can be factored in for proper coverage.

The container 30 holds a mixture of super absorbent polymer and a predetermined amount of water to obtain an admixture that will stay in suspension for long periods of time and, with minimal movement of the container, can remix any polymer that settles. The container 30 can be sized from 5 to 50 gallons with a preferred capacity of about 15 gallons. The container 30 is preferably constructed from stainless steel capable of maintaining a static pressure of 300 psi, using a relief valve 36 set for 350 psi relief. While stainless steel provides a most rugged material, the use of aluminum is acceptable and even preferred should weight be an issue. For instance, the related components are skid mounted for ease of mounting in a vehicle and shipping purposes should a discharge occur and refurbishing is necessary. While movement is not deemed necessary in temperate climates such as the southern United States, areas subject to freezing will benefit from either the skid being placed in a warm environment or the use of a tank heater 38 that can be placed external the container. It should be noted that various anti-freezing agents may be included with the admixture without defeating the purpose of this invention. However, the current admixture is environmentally friendly and any discharge that falls upon vegetation will be of benefit.

The admixture is directed into the aerial bucket 12 by use of a distribution ring 20 that is fluidly coupled by a fluid hose 24. The hose can be 50 foot long allowing the placement of the container 30 a distance from the distribution ring 20. Stainless steel quick release couplings 40 and 42, such as those manufactured by the Eaton Corporation, are used to connect the container 30 to the fluid hose 24 and to the distribution ring 20. The distribution ring 20 is constructed and arranged to be placed about the circumference of the aerial bucket 12 so that an individual can enter and exit through the top of the aerial bucket 12 uninhibited. The distribution ring 20 has a plurality of spray nozzles 32 to direct the admixture into the bucket should an individual require fire protection. The spray nozzles distribute the hydrated admixture in sufficient quantity to cover the individual. If the individual's clothing is on fire, the admixture will extinguish the fire and suppress the spread of the fire. The admixture will also protect the individual's skin from exposure to the fire. Further, the admixture will inhibit the fire from damaging the integrity of the ladder so as to provide the individual with sufficient time to exit the bucket. The distribution ring 20 is formed from 3/8″ stainless steel tubing with sorat nozzles 32 secured along an inner side surface 44. A spray nozzle guard 46 is spaced apart from the inner side surface 44 by use of bridge supports 48. The spray nozzle guard prevents clothing from snagging on spray nozzles. It should be noted that while the nozzles can be formed integral with the distribution ring, the cost of forming the nozzle into the distribution ring was not considered as economical.

The container 30 is filled with the FireIce® mixture through access opening 50. The admixture is formed from FireIce® with a concentration of 90 grams per 2.5 gallons of distilled water. The container is then pressurized to about 300 psi by use of charging cylinders 52 and 54. Two charging cylinders are used to reduce the space needed for a charging cylinder and take advantage of commercially available charged cylinders. Sensor 56 monitors the pressure to assure the container 30 is properly charged. Pressure sensors 58 and 60 are used to monitor the pressure of each cylinder. A manual shutoff 62 is positioned on the discharge 64 of the container 30. An emergency bypass manual valve 66 is provided to allow a co-worker monitoring the operation to discharge the container 30 into the fluid hose 24 and dispersing ring 20. A solenoid 68 is also positioned on the container 30, allowing for a remote discharge by an activator 70 tethered to the solenoid 68 by a cable 72. Should a need occur, the co-worker monitoring the lineman may activate the system by depressing a trigger switch located on the activator 70 which opens the solenoid 68 allowing for the disbursement of the admixture. The cable 72 can be of a length that allows the co-worker quick access for disbursement, yet freedom to continue other duties; or the cable 72 can be adjoined to the fluid hose 24 and a trigger switch mounted within the bucket. Placement of the trigger switch may include a top 16 mounted trigger switch 80, or alternatively a trigger switch 82 is placed along the bottom 17 of the aerial bucket 12. A shield 84 can be placed around the trigger switch 82 to prevent accidental operation, yet allow either hand operation or operation initiated by the lineman's foot. Any combination of the cable operated triggers may be used, or all three, wherein operation can be caused by the top trigger 80, bottom trigger 82 or the remote trigger 70 held by a co-worker.

A wireless transmitter 90 which operates on a radio frequency may also be used. In a preferred embodiment, a 2.4 GHz transmitter 90 is used to signal the solenoid 68 in a similar manner as the aforementioned hard wired triggers. The wireless transmitter 90 can be mounted to a wrist band, attached to the lineman's belt, or otherwise placed at any location that is easily accessible to the lineman or his co-worker. A proximity sensor can be used to assure the transmitter and solenoid receiver is within operating range, with a flashing light on both the solenoid and the receiver to indicate if the devices are out of range. It should be noted that while a wrist band is described, any type of attachment convenient to the individual is contemplated, including a pendant worn around the neck and belt attachment similar to a garage door opener bracket. Battery condition of the solenoid, whether operated by a cabled trigger switch or a wireless transmitter can be verified by use of an indicator light that indicates if the condition of the battery is sufficient for operation. Another light indicator can be employed to verify the container is filled with fluid and pressurized. Lithium battery technology would allow a replacement period expected to exceed ten years as the system is to be used only for emergencies, and the battery draw during that time would be limited to low draw LED operational indicator lights.

The viscosity of the admixture of super absorbent polymer allows attachment to whatever is sprayed. Spraying the individual's clothing and exposed skin is most preferred. The admixture provides fire extinguishing qualities as well as fire and heat retardant properties. While linemen servicing power poles is defined as example above, any use of an aerial bucket is deemed within the scope of this invention including firefighting aerial buckets found on fire trucks. All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An aerial bucket lift fire safety apparatus comprising:
a container capable of holding pressurized hydrated super absorbent polymer;
a predetermined admixture of hydrated super absorbent polymer stored within said container;
at least one charging cylinder coupled to said sealed container for pressurization of said container storing said admixture;
a distribution ring securable to an aerial bucket lift and fluidly coupled to said container, said distribution structure having at least one spray nozzle; and
at least one remote activator positioned between said container and said distribution ring for releasing said stored admixture of hydrated super absorbent polymer into said aerial bucket.

2. The aerial bucket lift fire safety apparatus device according to claim 1 wherein said distribution ring is constructed and arranged to secure to the top surface of an aerial bucket.

3. The aerial bucket lift fire safety apparatus device according to claim 2 wherein said distribution ring includes a guard to shield said spray nozzle, whereby said guard inhibits clothing from snagging on said spray nozzle.

4. The aerial bucket lift fire safety apparatus device according to claim 1 wherein said distribution ring has a plurality of spray nozzles to provide an overlapping spray pattern of said admixture.

5. The aerial bucket lift fire safety apparatus device according to claim 1 wherein said container is coupled to said distribution ring by a flexible hose, said flexible hose having a quick connect at a first end for coupling to said container and a quick connect at a second end for coupling to said distribution ring.

6. The aerial bucket lift fire safety apparatus device according to claim 1 wherein said remote activator is coupled to a battery operated solenoid positioned between said container and said distribution ring.

7. The aerial bucket lift fire safety apparatus device according to claim 1 wherein said remote activator is a battery operated solenoid.

8. The aerial bucket lift fire safety apparatus device according to claim 7 including at least one remote trigger electrically coupled to said battery operated solenoid.

9. The aerial bucket lift fire safety apparatus device according to claim 8 wherein said remote trigger is coupled by an electrical wire.

10. The aerial bucket lift fire safety apparatus device according to claim 9 wherein a remote trigger is secured along a top surface of said aerial bucket.

11. The aerial bucket lift fire safety apparatus device according to claim 9 wherein a remote trigger is secured along a lower surface of said aerial bucket.

12. The aerial bucket lift fire safety apparatus device according to claim 8 wherein said remote trigger is a wireless transmitter and said battery operated solenoid includes a wireless receiver.

13. The aerial bucket lift fire safety apparatus device according to claim 1 wherein said polymer is FireIce®.

14. An aerial bucket lift fire safety apparatus comprising:
a container capable of holding pressurized hydrated super absorbent polymer;
a predetermined admixture of hydrated super absorbent polymer stored within said container;
at least one charging cylinder coupled to said sealed container for pressurization of said container storing said admixture;
at least one spray nozzle fluidably coupled to said container;
a battery operated solenoid secured to a pressurized outlet of said container; and
at least one remote activator for opening of said solenoid for releasing said stored admixture of hydrated super absorbent polymer into said aerial bucket.

15. The aerial bucket lift fire safety apparatus device according to claim 14 wherein said spray nozzle is secured along the top surface of an aerial bucket.

16. The aerial bucket lift fire safety apparatus device according to claim 14 wherein said container is coupled to said spray nozzle by a flexible hose, said flexible hose having a quick connect at a first end for coupling to said container and a quick connect at a second end for coupling to said spray nozzle.

17. The aerial bucket lift fire safety apparatus device according to claim 14 wherein said remote activator is coupled to a battery operated solenoid positioned between said container and said distribution ring.

18. The aerial bucket lift fire safety apparatus device according to claim 14 wherein said remote trigger is coupled to said battery operated solenoid by an electrical wire.

19. The aerial bucket lift fire safety apparatus device according to claim 14 wherein said remote trigger is further defined as a wireless transmitter and said battery operated solenoid includes a wireless receiver.

20. The aerial bucket lift fire safety apparatus device according to claim 14 wherein said polymer is FireIce®.
